(19) United States
(12) Patent Application Publication
(10) Pub. No.: US 2016/0093959 A1
(43) Pub. Date: Mar. 31, 2016

(54) PLUG-IN BRIDGE HAVING PLATE ELEMENTS LYING ONE OVER THE OTHER

(71) Applicant: PHOENIX CONTACT GMBH & CO. KG, Blomberg (DE)

(72) Inventors: Juergen Feye-Hohmann, Detmold (DE); Ralf Beckmann, Detmold (DE)

(21) Appl. No.: 14/892,200

(22) PCT Filed: May 13, 2014
(86) PCT No.: PCT/EP2014/059750

§ 371 Date: Nov. 19, 2015

(30) Foreign Application Priority Data
May 21, 2013 (DE) 10 2013 105 148.0

(51) Int. Cl. H01R 4/48

(52) U.S. Cl. CPC H01R 4/4809

(57) ABSTRACT

A plug-in bridge for connecting at least two electrical fiat contacts includes a resilient contact fork having an open side for inserting a first of the at least two electrical flat contacts and further having two opposite contact fingers for electrically contacting the first electrical flat contact, two plate elements lying one over the other, each of the two plate elements having at least one of the two opposite contact fingers formed thereon, and a clamping spring. The two plate elements are connectable by attaching the clamping spring to the two opposite contact fingers thereby forming the contact fork.

### CROSS REFERENCE TO RELATED APPLICATIONS

This application is a U.S. National Stage Application under 35 U.S.C. §371 of International Application No. PCT/EP2014/059750 filed on May 13, 2014, and claims benefit to German Patent Application No. 10 2013 105 148.0 filed on May 21, 2013. The International Application was published in German on Nov. 27, 2014 as WO 2014/187697 A1 under PCT Article 21(2).

### FIELD

The present invention relates to a plug-in bridge for connecting at least two electrical flat contacts.

### BACKGROUND

In order to interconnect various connection terminals having the same potential, cross connectors are commonly used, which are also referred to as potential bridges or simply bridges. One type of such a cross connector is a plug-in bridge, in which resilient contact forks having opposite contact fingers are inserted into the connection terminals to be bridged. The contact forks are slid onto flat contacts of the connection terminals by elastically deforming the contact fingers of the forks. The contact forks are electrically conductively interconnected by means of a conductive connection element, which can be designed as a connecting piece for example.

The plug-in bridge is formed in the prior art by bending a plate element, and therefore the contact fingers are arranged on opposite ends of the bent plate element and form the contact fork.

Such known plug-in bridges are rather unsuitable for transferring large currents, since a large spring force is required in order to ensure reliable electrical contact between the flat contact and the contact fork. Usually, the plug-in bridges are likewise designed to be flat to correspond with the flat contacts, as a result of which the spring force of the contact forks is small. The production of these known plug-in bridges is also complex.

### SUMMARY

According to an embodiment, a plug-in bridge for connecting at least two electrical flat contacts is provided. The plug-in bridge includes a resilient contact fork having an open side for inserting a first of the at least two electrical flat contacts and further having at least two opposite contact fingers for electrically contacting the first electrical flat contact; first and second plate elements lying one over the other, each of the plate elements having at least one of the opposite contact fingers formed thereon; and a clamping spring. The plate elements are connectable by an attaching of the clamping spring to the respective opposite contact fingers thereby forming the contact fork.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a plan view of a plug-in bridge according to a first embodiment of the invention having two flat contacts to be bridged,

FIG. 2 is a sectional side view of the plug-in bridge of FIG. 1,

FIG. 3 is a perspective view of a clamping spring of the plug-in bridge from FIG. 1,

FIG. 4 is a perspective view of a plug-in bridge according to a second embodiment of the invention having an additional insulation housing,

FIG. 5 is a rear view of the plug-in bridge of FIG. 4,

FIG. 6 is a sectional view along a longitudinal axis of a plug-in bridge according to a third embodiment of the invention having two flat contacts to be bridged,

FIG. 7 is a perspective view of a plug-in bridge according to a fourth embodiment of the invention having two flat contacts to be bridged,

FIG. 8 is a side view of the plug-in bridge of FIG. 7, and

FIG. 9 is a rear view of the plug-in bridge of FIG. 7.

### DETAILED DESCRIPTION

An embodiment of the invention provides a plug-in bridge which is simple to produce, which can be used universally, which is suitable for transferring large currents, and which has a flat construction.

According to an embodiment of the invention, a plug-in bridge for connecting at least two electrical flat contacts includes a resilient contact fork for inserting a flat contact from the open side of the fork, the contact fork having at least two opposite contact fingers for electrically contacting the flat contact, wherein the plug-in bridge has two plate elements lying one over the other, at least one contact finger is formed on each of the plate elements lying one over the other and the plug-in bridge has a clamping spring, the plate elements being connectable by attaching the clamping spring to two opposite contact fingers, thereby forming the contact fork.

A concept of an embodiment of the present invention is forming the contact fork in a simple manner so as to have two plate elements lying one over the other which are interconnected using the clamping spring. The flat contact can be inserted into the contact fork formed in this way. This plug-in bridge is simple to produce since the plate elements are formed in a simple manner and can be produced by means of simple tools. The plate elements are connected by attaching the clamping spring so that no complex connecting methods are required. The plate elements are preferably designed as punched-out elements and therefore the machining can be carried out in a simple manner. The plate elements are more preferably brought into their desired shape by a pressing method. The desired spring force can be set by the clamping spring, with which force the contact fingers press against the flat contact in the plugged-in state. The flat contacts can thereby be contacted in a reliable manner, and it is possible to transfer large currents by means of the plug-in bridge. At the same time, the plug-in bridge has a flat construction.

The plate elements are preferably made of copper or another material which has good electrical conductivity. The plate elements particularly preferably have a coating made of a material which has a high level of conductivity, in particular gold.

The plate elements are preferably electrically conductively interconnected by means of a connecting piece. The connecting piece is preferably made of copper or another material which has a high level of electrical conductivity. The connecting piece particularly preferably has a coating made of a material which has a high level of conductivity, in particular gold.

In one preferred embodiment, the connecting piece is integrally formed with at least one plate element. The connecting piece is more preferably integrally formed with both plate elements. The plate elements are particularly preferably located on top of one another in the region of the connecting piece.

The clamping spring is preferably designed as a steel spring. The clamping spring is particularly preferably made of spring steel. The contact force can be set by selecting the material, the material thickness and the configuration of the clamping spring.

In one advantageous embodiment of the invention, the plug-in bridge has an insulation housing. The insulation housing prevents electrically conductive regions of the plug-in bridge from being contacted, in particular in a grip region for attaching or removing the plug-in bridge. The insulation housing has openings for receiving the flat contacts to be bridged.

In one advantageous embodiment of the invention, the two opposite contact fingers have corresponding guides for sliding the clamping spring. The guides are preferably designed as guide grooves. The guides are particularly preferably designed as guide slots. The guides make simple attachment of the clamping spring possible by sliding it onto the plate elements lying one over the other.

The contact fingers more preferably have a pressure region in the end region thereof for inserting the flat contact, and the clamping spring is designed such that it presses on the pressure region in the installed state. Correspondingly, the guide ends shortly before the pressure region, which forms a contact surface of the spring arms of the clamping spring on the two contact fingers. The clamping spring can be slid into the guides and is only spread apart when the pressure region has been reached. As a result, the plug-in bridge only requires a small amount of space in addition to the thickness of the flat contacts to be inserted. The clamping spring can also be installed with little force, i.e. with a small amount of effort.

In one advantageous embodiment of the invention, the plug-in bridge is designed such that the clamping spring can be attached to the contact fingers from the side opposite the open side of the contact fork. An end region of the clamping spring is preferably located in the region for inserting the flat contact, and therefore a large force can be applied to the contact fork in this region.

In one advantageous embodiment of the invention, the clamping spring is designed as a planar plate spring element. The clamping spring is preferably designed as a punched-out element. The clamping spring can therefore have a high level of strength and is simple to manufacture. The clamping spring can also have a small thickness, as a result of which it has a small edge on the contact fingers.

In one advantageous embodiment of the invention, the plug-in bridge has a plurality of clamping springs, the plate elements being connectable by attaching the plurality of clamping springs to two opposite contact fingers, thereby forming the contact fork. By increasing the number of clamping springs per contact finger pair, the force for clamping the flat contact can be set as appropriate.

In one advantageous embodiment of the invention, the clamping spring has a plurality of spring arm pairs. The force of the spring can be increased by the plurality of spring arm pairs. A simple setting of the force of the clamping spring is also possible. At the same time, a uniform contact pressure can be exerted on the flat contact received in the contact fork.

In one advantageous embodiment of the invention, the plug-in bridge has two resilient contact forks for inserting a flat contact in each case, the contact fingers of the two contact forks are formed on the two plate elements lying one over the other, and the plug-in bridge has at least two clamping springs, the plate elements being connectable by attaching the at least two clamping springs, thereby forming the two contact forks. The clamping springs are preferably evenly distributed over the contact forks such that at least one clamping spring is attached or can be attached in the region of each flat contact. The plug-in bridge particularly preferably has two plate elements in total, the two contact forks being formed to have the same two plate elements. The configuration of the plate elements is in principle arbitrary. The plate elements can, for example, be arranged on top of one another in a substantially planar manner, or can have a slot and can intersect one another. In contrast with the prior art, a break in a connecting piece between the two contact forks by means of a slot in the longitudinal direction is unnecessary.

In one advantageous embodiment of the invention, the opposite plate elements have positioning elements for positioning on top of one another. The positioning elements can be correspondingly formed on the two plate elements or only on one of the plate elements. The positioning elements are preferably designed as opposite holes and pins. The positioning elements facilitate accurate positioning of the plate elements on top of one another. Furthermore, unintentional sliding of the plate elements relative to one another is prevented in particular before the clamping spring is attached.

In one advantageous embodiment of the invention, the opposite plate elements are identically designed. Therefore, only one type of plate element is to be provided for the plug-in bridge, as a result the installation thereof is facilitated. The plug-in bridge is particularly advantageously formed overall by two identical plate elements. The plate elements are preferably prevented from being contacted using an insulation housing.

In one advantageous embodiment of the invention, the contact fork has a plurality of corresponding contact fingers for contacting a flat contact, and the plug-in bridge has at least a number of clamping springs which corresponds to the plurality of contact fingers, the plate elements being connectable by attaching at least one clamping spring to two opposite contact fingers in each case, thereby forming the contact fork. Correspondingly, the plug-in bridge can contact a flat contact or a plurality of flat contacts of a connection contact using the plurality of corresponding contact fingers, as a result of which the current-carrying capacity of the plug-in bridge is increased. The plug-in bridge preferably comprises a plurality of clamping springs which can be attached to a plurality of opposite contact fingers.

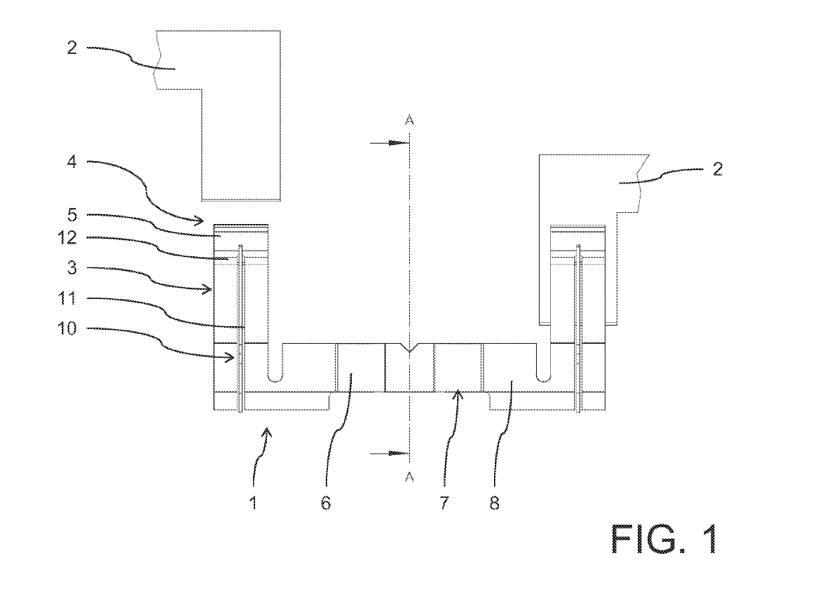

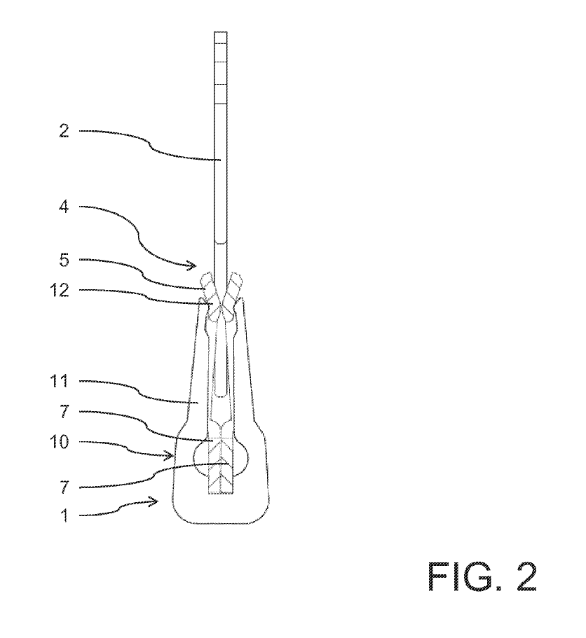

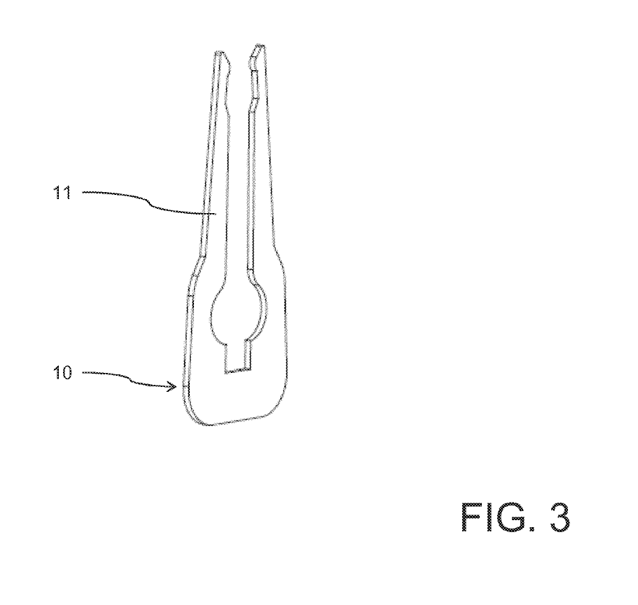

FIGS. 1 to 3 show a plug-in bridge 1 according to a first embodiment, having two electrical flat contacts 2 to be bridged.

The plug-in bridge 1 comprises two resilient contact forks 3 for inserting the flat contacts 2 from the open side 4 of the contact forks 3. The contact forks 3 have in each case two opposite contact fingers 5 for electrically contacting the flat contacts 2. The contact forks 3 are electrically conductively interconnected by means of a connecting piece 6.

The contact forks 3 and the connecting piece 6 are formed with two plate elements 7 lying one over the other. The plate elements 7 are designed as identical, pressed punched-out elements made of copper. The plate elements 7 are designed such that a contact finger 5 of each contact fork 3 is arranged on each of the plate elements 7, the contact fingers 5 being connected in each case by a bar 8. The bars 8 lying one over the other together form the connecting piece 6.

Corresponding guides 9 are formed in the opposite contact fingers 5 in each case, which guides are designed as guide slots. The guide slots 9 are arranged such that they extend from the side opposite the open side 4 of the contact fork 3 towards the ends of the contact fingers 5.

The plug-in bridge furthermore has two clamping springs 10 for connecting the plate elements 7. The clamping springs 10 are designed as planar plate spring elements which are manufactured by punching out of spring steel. The clamping springs 10 are correspondingly designed in each case to have two spring arms 11.

The plate elements 7 are connectable by attaching the two clamping springs 10 to two opposite contact fingers 5 in each case, thereby forming the two contact forks 3. To do this, the two clamping springs 10 are each slid from the side opposite the open side 4 of the contact forks 3 onto said forks, the spring arms 11 of the clamping spring being slid into the guides 9. The sliding therefore takes place towards the open end 4 of the contact fork 3.

An end region of the spring arms 11 of the clamping spring 10 comes into contact with a pressure region 12 of the contact finger 5 when it is slid onto the relevant contact fork 3. The pressure region 12 is formed at the end of the guide slot 9. In the installed state, the end regions of the spring arms 11 press against the relevant pressure region 12, which therefore forms a contact surface of the spring arms 11 of the clamping spring 10 on the two contact fingers 5. The clamping spring 10 is spread apart when the pressure region 12 has been reached so that a spring force acts on the pressure regions 12.

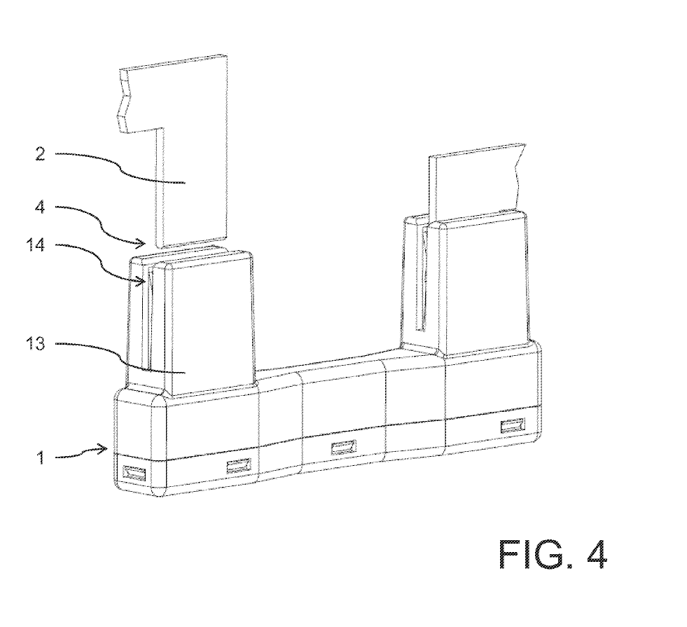

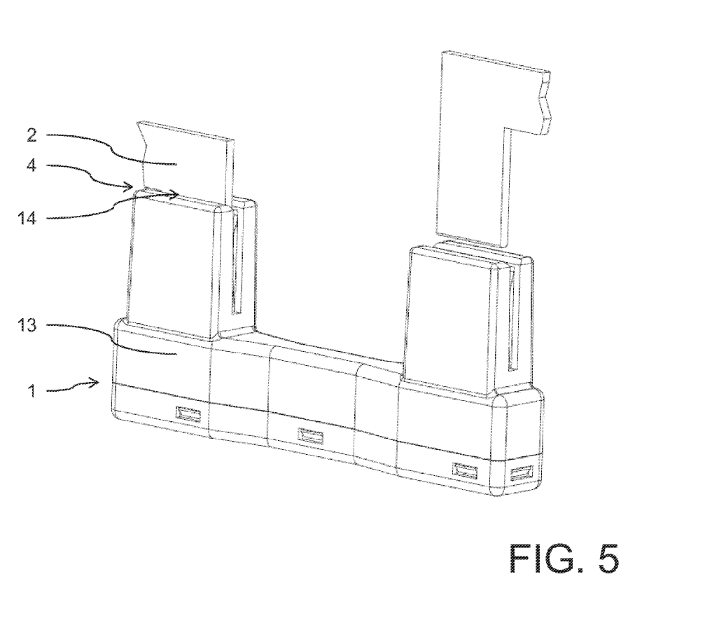

FIGS. 4 and 5 show a plug-in bridge 1 according to a second embodiment, having two electrical flat contacts 2 to be bridged.

The plug-in bridge 1 according to the second embodiment comprises the plug-in bridge 1 of the first embodiment and an additional insulation housing 13. The insulation housing 13 surrounds the connected plate elements 7 including the clamping springs 10, the insulation housing 13 having, at the open ends 4 of the contact forks 3, insertion openings 14 for inserting the flat contacts 2.

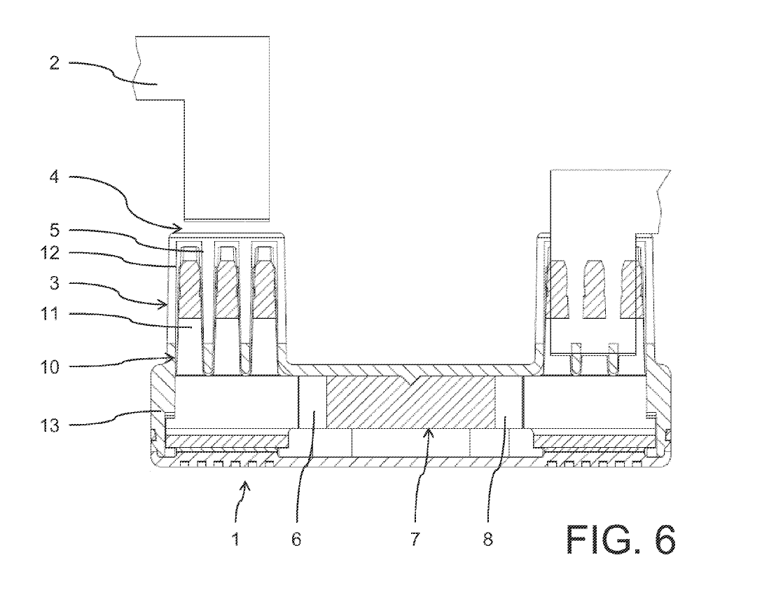

FIG. 6 shows a plug-in bridge 1 according to a third embodiment, having two electrical flat contacts 2 to be bridged.

The structure of the plug-in bridge 1 according to the third embodiment comprises two plate elements 7, as described with reference to the plug-in bridge 1 of the first embodiment, the contact fingers 5 being designed, however, so as to deviate from those of the first embodiment without a guide 9.

The plug-in bridge 1 according to the third embodiment further comprises two clamping springs 10 which are designed in each case to have three opposite pairs of spring arms 11. The clamping springs 10 are each slid from the side opposite the open side 4 of the contact forks 3 onto said forks, as in the case of the plug-in bridge 1 of the first embodiment. The sliding therefore takes place towards the open end 4 of the contact fork 3.

An end region of the spring arms 11 of the clamping spring 10 comes into contact with a pressure region 12 of the contact finger 5 when it is slid onto the relevant contact fork 3. The pressure region 12 is formed on the open end 4 of the relevant contact fork 3. In the installed state, the end regions of the spring arms 11 press against the relevant pressure region 12, which therefore forms a contact surface of the spring arms 11 of the clamping spring 10 on the two contact fingers 5.

The plug-in bridge 1 according to the third embodiment further comprises an insulation housing 13, as described with reference to the plug-in bridge of the second embodiment.

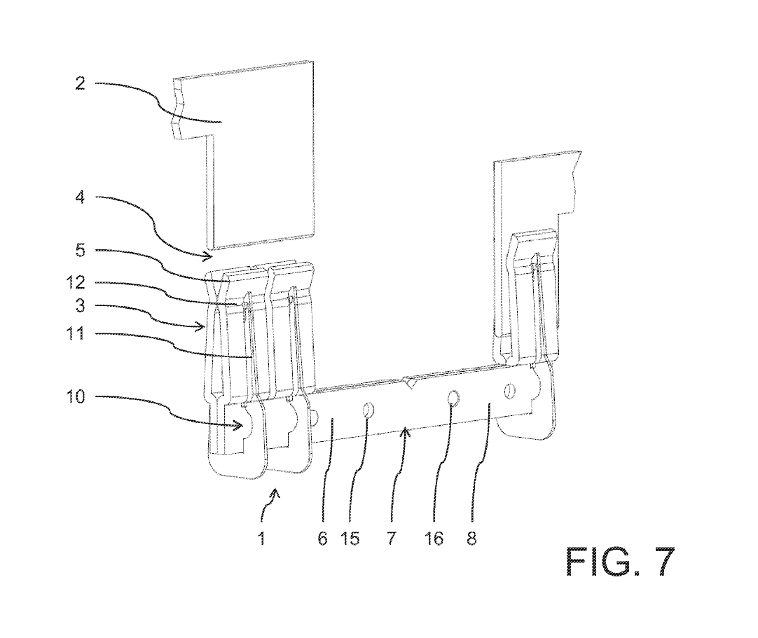

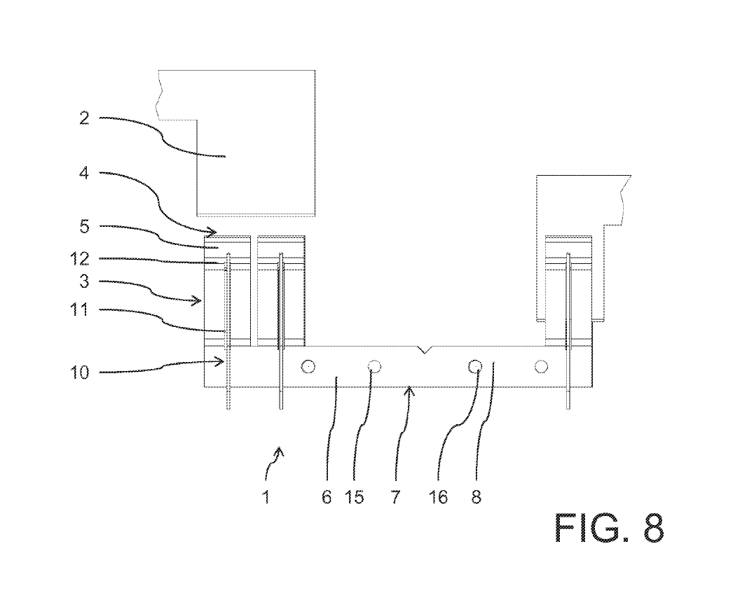

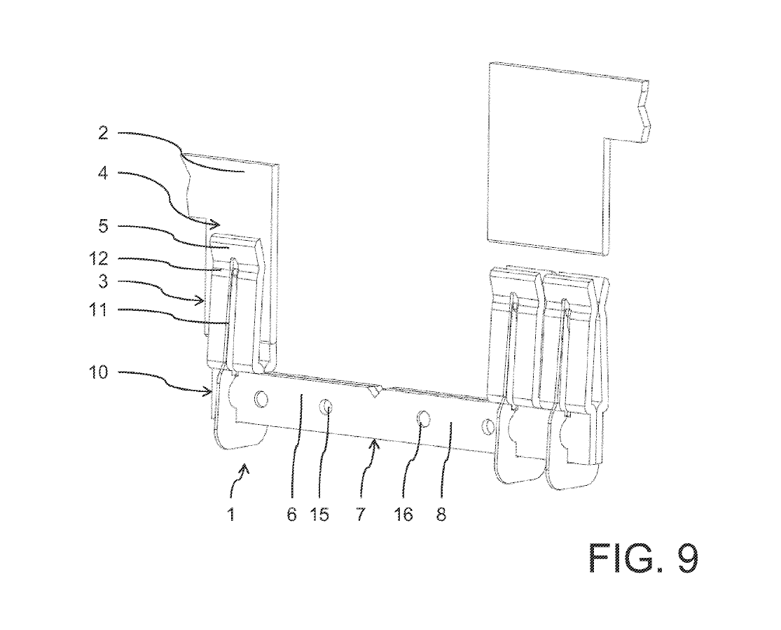

FIGS. 7 to 9 show a plug-in bridge 1 according to a fourth embodiment, having two electrical flat contacts 2 to be bridged.

The plug-in bridge 1 comprises three resilient contact forks 3 for inserting the flat contacts 2 from the open side 4 of the contact forks 3. The contact forks 3 each have two opposite contact fingers 5 for electrically contacting the flat contacts 2, two of the contact forks 3 contacting a flat contact 2, while the other contact fork 3 contacts a flat contact 2 alone. The contact forks 3 are electrically conductively interconnected by means of a connecting piece 6.

The contact forks 3 and the connecting piece 6 are formed from two plate elements 7 lying one over the other. The plate elements 7 are designed as pressed punched-out elements made of copper. The plate elements 7 are designed such that a contact finger 5 of each contact fork 3 is arranged on each of the plate elements 7, the contact fingers 5 being connected in each case by a bar 8. The bars 8 lying one over the other together form the connecting piece 6.

The opposite plate elements 7 have positioning elements 15, 16 for positioning on top of one another. The positioning elements are designed as opposite holes 15 and pins 16 which are correspondingly formed on the two plate elements 7, as indicated in the drawings.

Corresponding guides 9 are formed in the opposite contact fingers 5 in each case, which guides are designed as guide slots. The guide slots 9 are arranged such that they extend from the side opposite the open side 4 of the contact fork 3 towards the ends of the contact fingers 5.

The plug-in bridge furthermore has three clamping springs 10 for connecting the plate elements 7. The clamping springs 10 are designed as planar plate spring elements which are manufactured by pressing from spring steel. The clamping springs 10 are correspondingly designed in each case to have two spring arms 11.

The plate elements 7 are connectable by attaching the clamping springs 10 to two opposite contact fingers 5 in each case, thereby forming the three contact forks 3. To do this, the clamping springs 10 are each slid from the side opposite the open side 4 of the contact forks 3 onto said forks, the spring arms 11 of the clamping spring being slid into the guides 9. The sliding therefore takes place towards the open end 4 of the relevant contact fork 3.

An end region of the spring arms 11 of the clamping spring 10 comes into contact with a pressure region 12 of the contact fingers 5 when it is slid onto the relevant contact fork 3. The pressure region 12 is formed at the end of the guide slot 9. In the installed state, the end regions of the spring arms 11 press against the relevant pressure region 12, which therefore forms a contact surface of the spring arms 11 of the clamping spring 10 on the two contact fingers 5. The clamping spring 10 is spread apart when the pressure region 12 has been reached so that a spring force acts on the pressure regions 12.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Plug-in bridge 1

Flat contact 2

Contact fork 3

Open side 4

Contact finger 5

Connecting piece 6

Plate element 7

Bar 8

Guide, guide slot 9

Clamping spring 10

Spring arm 11

Pressure region 12

Insulation housing 13

Insertion opening 14

Positioning element, hole 15

Positioning element, pin 16

1. A plug-in bridge for connecting at least two electrical flat contacts, the plug-in bridge comprising:
a resilient contact fork having an open side for insetting a first of the at least two electrical flat contacts and further having at least two opposite contact fingers for electrically contacting the first electrical flat contact,
first and second plate elements lying one over the other, each of the plate elements having at least one of the opposite contact fingers formed thereon;
a clamping spring,
wherein the plate elements are connectable by an attaching of the clamping spring to the respective opposite contact fingers, thereby forming the contact fork.

2. The plug-in bridge according to claim 1, wherein
the opposite contact fingers have corresponding guides for sliding the clamping spring.

3. The plug-in bridge according to claim 1, wherein
the plug-in bridge is designed such that the clamping spring can be attached to the respective opposite contact fingers from a side opposite the open side of the contact fork.

4. The plug-in bridge according to claim 1, wherein
the clamping spring is designed as a planar plate spring element.

5. The plug-in bridge according to claim 1, wherein
the plug-in bridge comprises a plurality of clamping springs, and
wherein the plate elements are connectable by an attaching of the plurality of clamping springs to the respective opposite contact fingers, thereby forming the contact fork.

5. The plug-in bridge according to claim 1, wherein
the clamping spring includes a plurality of spring arm pairs.

7. The plug-in bridge according to claim 1, further comprising;
a second resilient contact forks for inserting a second of the at least two electrical flat contacts and having at least two opposite contact fingers for electrically contacting the second electrical flat contact,
wherein the contact fingers of each of the first resilient contact fork and the second resilient contact fork are formed on the plate elements lying one over the other, and
at least a second clamping springs, wherein the plate elements are connectable by attaching the first and the second clamping springs, thereby forming the first resilient contact fork and the second resilient contact forks.

8. The plug-in bridge according to claim 1, wherein
the plate elements have positioning elements for positioning on top of one another.

9. The plug-in bridge according to claim 1, wherein
the plate elements are identically designed.

10. The plug-in bridge according to claim 1, wherein
the resilient contact fork has a plurality of contact fingers for electrically contacting the first electrical flat contact,
wherein the plug-in bridge has at least a number of clamping springs that corresponds to the number of contact fingers, and
wherein the plate elements are connectable by attaching at least one of the number of clamping springs to two opposite ones of the contact fingers in each case thereby forming the contact fork.
